(19) United States
(12) Patent Application Publication
(10) Pub. No.: US 2014/0019056 A1
(43) Pub. Date: Jan. 16, 2014

(54) PROCESS FOR CHARACTERISING THE EVOLUTION OF AN OIL OR GAS RESERVOIR OVER TIME

(71) Applicant: Pierre Daniel Thore, Aberdeen (GB)

(72) Inventor: Pierre Daniel Thore, Aberdeen (GB)

(73) Assignee: TOTAL S.A., PARIS LA DEFENSE CEDEX (FR)

(21) Appl. No.: 14/002,641

(22) PCT Filed: Mar. 27, 2012
(86) PCT No.: PCT/GB12/50675

§ 371 Date: Sep. 24, 2013

(30) Foreign Application Priority Data
Mar. 29, 2011 (GB) 1105294.1

(51) Int. Cl. G01V 1/30; G01V 1/28

(52) U.S. Cl. CPC G01V 1/308; G01V 1/282
USPC 702/14

(57) ABSTRACT

Disclosed is a process for characterising the evolution of a reservoir that comprises non-horizontal layers, by analyzing the changes of at least the seismic amplitudes of seismic reflections. The process comprises the steps of providing a base survey of the reservoir with a set of seismic traces at a first time and providing a monitor survey of the reservoir, taken at a second time, with a set of seismic traces associated to the same positions as in the base survey. The sets of seismic traces from the base and monitor surveys are then inverted to obtain an estimate of the changes having occurred in the time interval between base and monitor surveys, the inversion being performed using seismic traces for which allowance is made for the actual propagation paths through the non-horizontal layers of the reservoir.

The present invention relates generally to the field of geosciences and more particularly to seismic data processing. Specifically the invention relates to a method to extract the time-lapsed changes in 3D seismic data sets collected over a production period to integrate with production data and assist in understanding and managing the extraction of oil and gas from reservoirs or the injection of other fluids into the reservoirs.

In the oil and gas industry, seismic surveys are carried out in order to provide subsurface images so that accumulations of hydrocarbons or other fluids might be identified. In a seismic survey, one or several sources emit elastic waves in the form of pressure or ground motion modulation from specific locations (wavefield), at or below the land or sea surface or in a borehole. This wavefield propagates away from the source(s) through the subsurface. Along with this propagation, a fraction of the incident wavefield is reflected from the fraction of the global heterogeneities in the elastic material properties of the subsurface (such as acoustic impedance). This excitation by the incident wavefield generates a reflected wavefield from the heterogeneities, which manifests as pressure, particle motion or some derived quantities and can be detected and recorded at the surface or in a borehole at a number of receiver locations.

Processing of the measurements is undertaken so as to construct a 3D image of the sub-surface. Repeated surveys at selected time intervals (days, months, years) allow observation of the changes in, over or under a given reservoir across the time interval—e.g. before oil or gas production starts and after some period of production or injection—and to compare the results of measurements. This is called 4D seismic and involves comparing 3D seismic surveys carried out at different time instances. The aim is to observe changes in the state of the formations and fluids consequent upon production of hydrocarbons from or the injection of fluids into a reservoir. Proper detection of the changes and proper identification of the effects, factors and processes requires specialised acquisition techniques and data processing steps.

Changes in the reservoir over time, due to exploitation, will cause changes to the petrophysical properties of the rock and therefore to the seismic velocity field. For example, oil will be substituted by gas or water and/or the fluid pressure will change, causing changes in saturation, and pressure, and consequently changes in velocity (P and S) and densities. Changes within the reservoir may also change the stress and strain state of the surrounding rocks, further causing changes in their velocities. These changes to velocity will produce time shifts in the seismic expression of underlying reflectors and associated changes in reflectivity, causing a change in the local wavefield.

In order to model these changes in the reservoir, a number of known inversion techniques are used. These are performed on surveys separated by a time interval to obtain an estimate of the changes having occurred in that time interval. Firstly, the data within the seismic data sets are realigned or conditioned to compensate for variations in acquisition (or non-repeatability of seismic surveys) and changes in velocity in the sub-surface.

One well known technique is that known as impedance inversion, where changes in impedance of the sub-surface are inverted for. Another technique makes use of cross-correlation between different vintages in selected windows. This is done in order to achieve alignment in time of the base and monitor surveys. This time alignment is measured by cross-correlation and applied to the monitor survey, which is therefore aligned with the base. The window is a time interval representing a portion of a trace and is set across traces for correlation, and thus should contain all the 4D effects.

Also recently developed are inversion techniques made possible using the tools known as Cal4D and Propagation4D. Cal4D, described in patent application FR 10/55945, attempts to find step (layer) perturbations at the well position. Propagation4D, described in patent application FR 10/57508, propagates this information from the wells to the rest of a 3D cube.

A further inversion technique (warping) is described in EP 1 865 340 to the

Applicant, and incorporated herein by reference, and comprises jointly inverting for the changes in the propagation times and seismic amplitudes of a seismic wavelet along propagation paths in the ground. By inverting it is possible to back filter, in effect, deriving the original from the solution.

However, in all these known inversion techniques, the wave propagation is simulated using a convolution model. This is valid only if the propagation is 1D, that is, vertical. Therefore all these approaches assume theoretically horizontal layers, and in practice mildly dipping layers (less than 10 degrees). Consequently, if an anomaly occurs at a depth z corresponding to time t, such as a change of velocity due to oil production, this change will only impact the same trace below this perturbation. Current 4D inversion techniques make this assumption. For example, this is the case for techniques which align the base and monitor sections by stretching and use an impedance inversion of the 4D anomaly, or other warping techniques which use, at the same time, the differential time and the change of amplitude to compute the 4D effect.

Consequently, when propagation is not vertical, as in the case of a dipping reservoir, this assumption fails and results obtained will at best be mere approximations, or possibly even false.

Even in methods which use pre-stack data (such as described in UK application GB1005646.3 which is hereby incorporated by reference), where multiple traces are used with different source and receiver positions to invert the same earth position, this assumption is still embedded into the technique, although it may be even less valid due to lateral changes.

At the other extreme, a completely different and much more general approach, called full waveform inversion (FWI), is under current development. This technique does not make any assumption on the type of geological model (it can handle all type of complexity) and therefore uses a full wave modelling approach for simulated wave propagation. The FWI is slower by a ratio of approximately 10⁹ compared to convolution and so the technique is limited in resolution to very low frequencies (15 Hz at most), which is insufficient for the reservoir scale and 4D inversion. Consequently, this technique is currently only applied in order to inverse for background velocity models rather than impedance contrast. It has never been applied to 4D inversion.

It is an object of the present invention to provide a process for characterising the evolution of a reservoir which alleviates or mitigates at least some of the problems in the prior art.

In a first aspect of the invention there is provided a process for characterising the evolution of a reservoir by analyzing the changes of at least the seismic amplitudes of seismic reflections, comprising the steps of:
providing a base survey of the reservoir with a set of seismic traces at a first time;
providing a monitor survey of the reservoir, taken at a second time, with a set of seismic traces associated to the same positions as in the base survey;
characterising the evolution of the reservoir by inversion of said sets of seismic traces from said base and monitor surveys to obtain an estimate of the changes having occurred in the time interval between base and monitor surveys,
wherein, where said reservoir comprises layers that are substantially non-horizontal, said inversion is performed using seismic traces for which allowance is made for the actual propagation paths through these non-horizontal layers.

Other optional features are as disclosed in the appended dependent claims.

Also disclosed is a computer program residing on a computer-readable medium and an apparatus for carrying out such a process.

A process embodying the invention will now be described, by way of example only, and with reference to the accompanying drawings, of which:

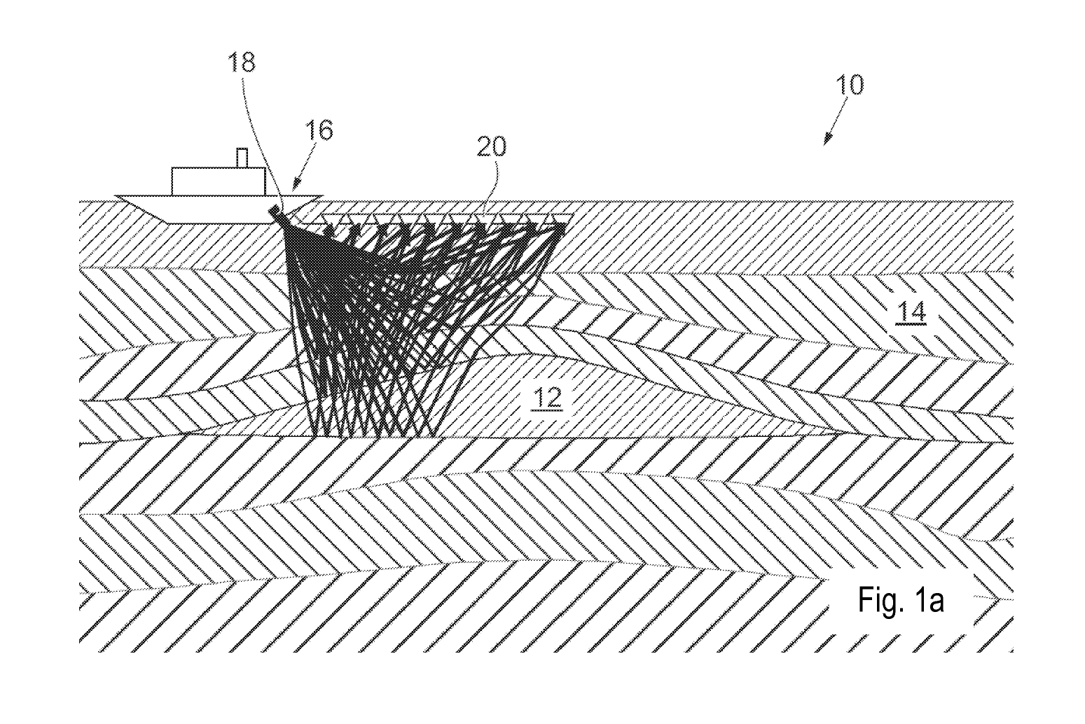

FIGS. 1a and 1b are schematic illustrations of a (1a) base survey and (1b) monitor survey being performed;

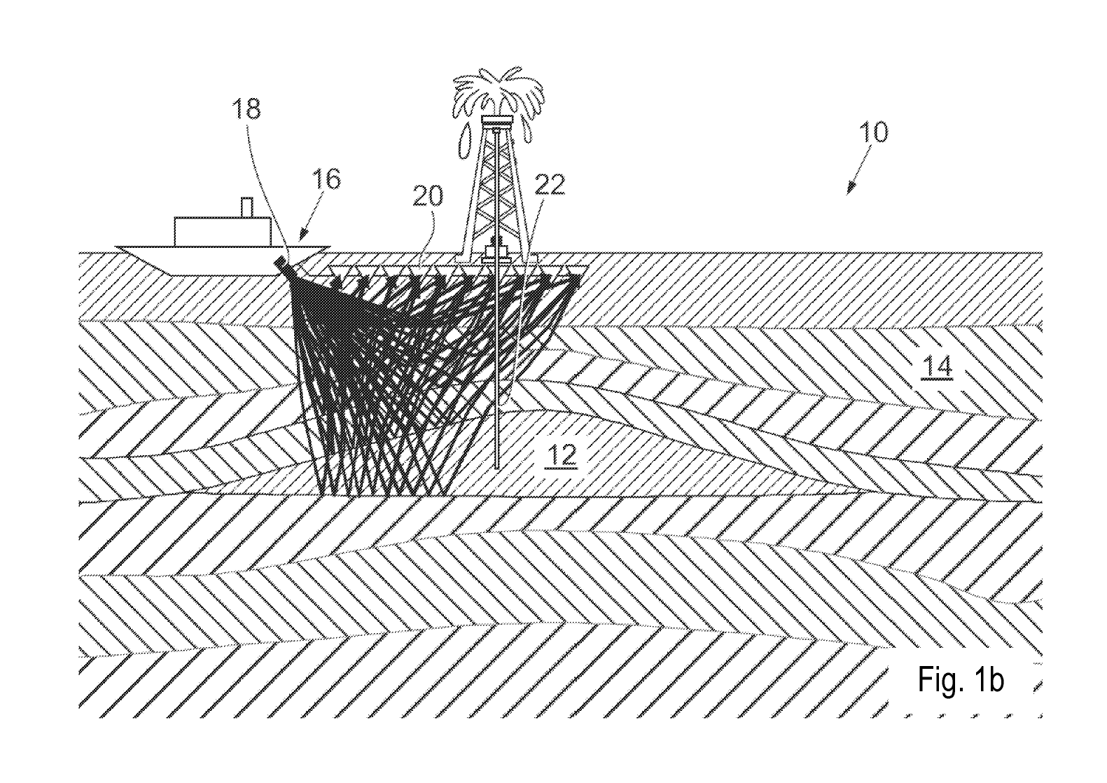

FIGS. 2a and 2b illustrate the effect of the present method on a reservoir with horizontal layers and non-horizontal layers respectively;

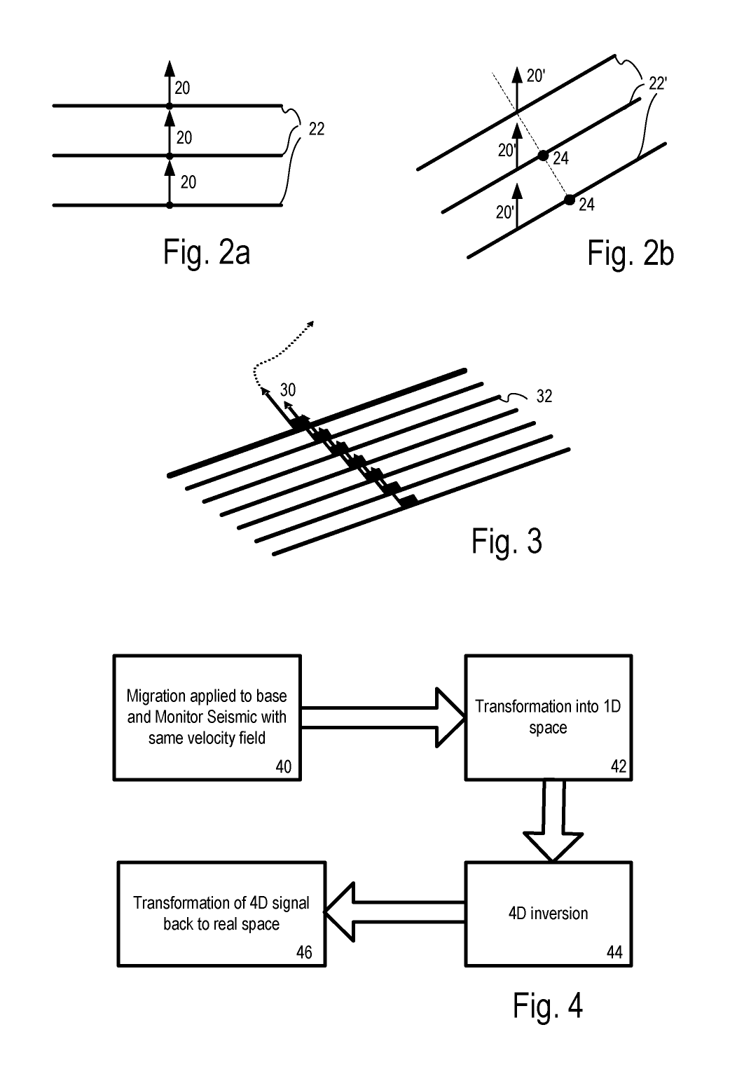

FIG. 3 illustrates the method according to the main embodiments of the invention;

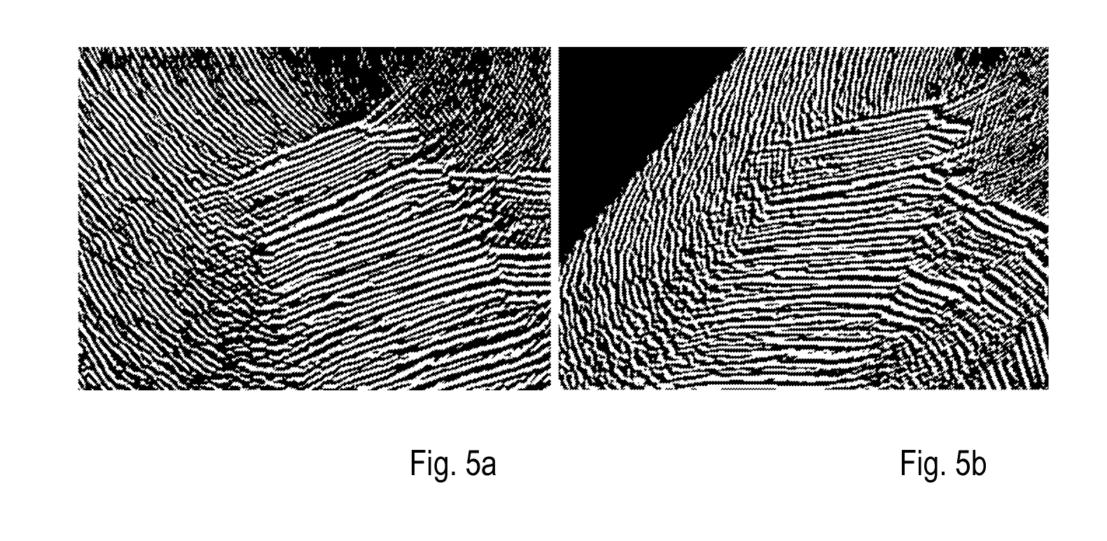

FIG. 4 is a flowchart of the method according to a main embodiment of the invention;

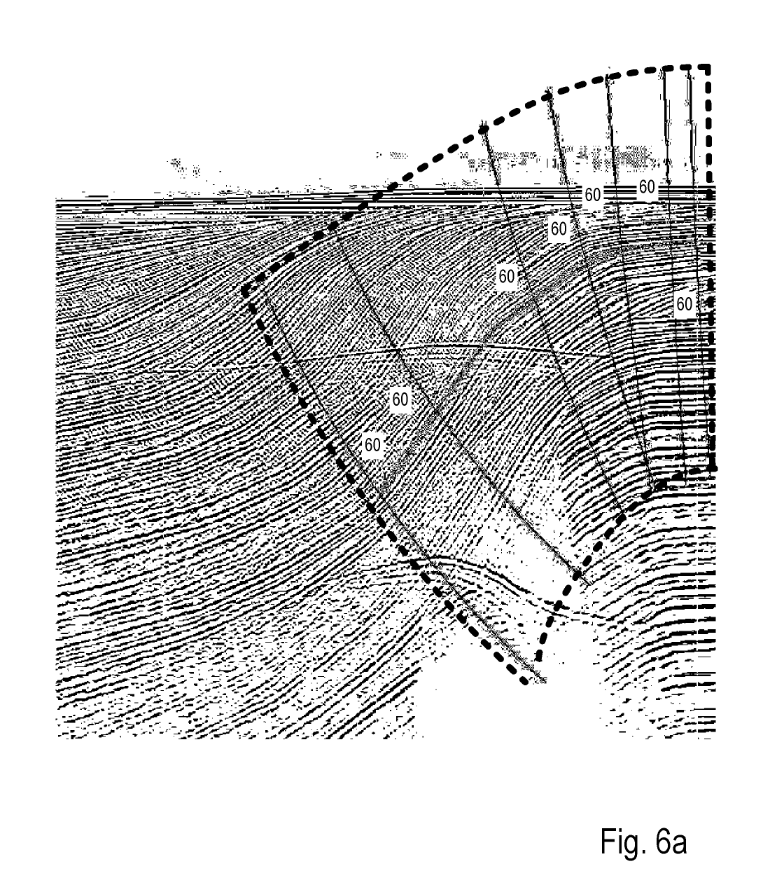

FIGS. 5a and 5b show the difference between a base and a monitor survey for a non-horizontal reservoir respectively, before and after a transformation in accordance with an embodiment of the invention;

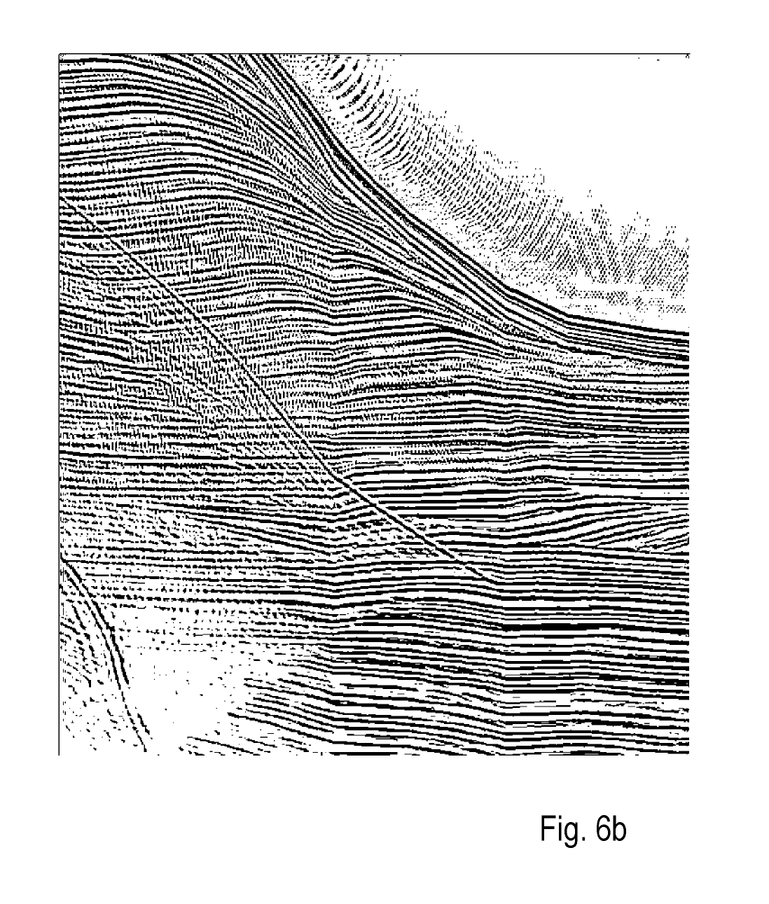

FIGS. 6a and 6b show the seismic results of a non-horizontal reservoir respectively before and after a transformation in accordance with another embodiment of the invention; and

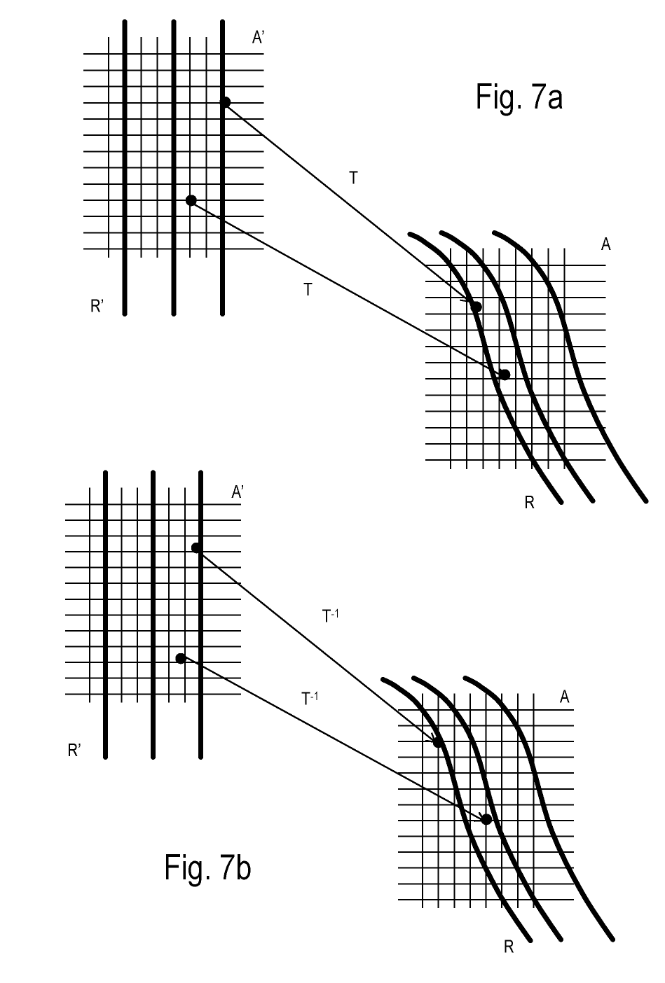

FIGS. 7a and 7b illustrate mapping techniques for getting back to normal space.

Referring initially to FIGS. 1a and 1b there is illustrated a reservoir, generally indicated by reference numeral 10, containing hydrocarbons 12 in the sub-surface 14. A survey vessel 16 upon which is located a sonar transmitter 18, being an acoustic source, and an array of receivers 20, performs a survey by travelling over the reservoir 10. The first or initial survey, FIG. 1a, may be referred to as a base survey and is typically performed in the exploration phase before production begins.

The base survey of the reservoir 10 provides a set of seismic traces at a first time T. For a given trace, the base survey provides amplitudes that are a function of time; with digital recording and processing the trace is sampled at a set of values; typical trace lengths correspond to around 1000 samples. The trace is then handled as a set of values.

One or more wells 22 may be drilled in order to extract the hydrocarbons 12. As the reservoir 10 is produced, hydrocarbons will be substituted by other fluids and the fluid pressure will change. Additionally, enhanced oil recovery techniques may be applied wherein a fluid is injected into the reservoir at one or more locations giving changes in fluid pressure and saturation. Changes within the reservoir may also change the stress and strain state of the surrounding rocks. Thus when a further survey is carried out, FIG. 2b, these changes will be seen due to a consequential change in the velocity field. These changes to velocity will produce time shifts in the seismic expression of underlying reflectors and associated changes in reflectivity, causing a change in the local wavefield.

Thus reservoir monitoring performs a monitor survey of the reservoir 10, taken at a second time T+ΔT, with a set of seismic traces. In the simplest assumption, ΔT is a positive quantity, and the monitor survey is taken at a time later than the base survey; however, the order in which the surveys are taken is irrelevant to the operation of the process of the invention and, in principle, the time lapse ΔT could as well be negative—which amounts to comparing the earlier survey to the later one. As for the base survey, a sampled trace in the monitor survey is represented as a set of values.

Ideally, the traces in the monitor survey are associated to the same positions as in the base survey. This is carried out by using, inasmuch as possible, the same equipment, acquisition geometry and processes for running the base and monitor surveys. Techniques such as interpolation may be used where traces in the monitor survey and in the base survey do not fulfill this condition.

As is known, inversion techniques such as warping can be applied for correcting the differences due to 4D changes between a base seismic and a monitor seismic. As previously mentioned, at the heart of all these inversion techniques is an assumption that the energy in each reservoir propagates vertically.

FIGS. 2a and 2b illustrate the current art and its main drawback. FIG. 2a shows reflectors 22 and the resultant traces of part of a first reservoir. As mentioned previously, it is assumed that the energy that has created all the traces 20 has propagated vertically, and that the reflectors 22 are therefore essentially horizontal. In the example of FIG. 2a, the reflectors are indeed horizontal, and any changes above a point will impact points vertically below. In this example, therefore, the current methods are sufficient.

FIG. 2b shows reflectors 22′ of part of a different reservoir with dipping, and therefore non-horizontal layers, and supposed propagation path 20′. As before, the current art assumes that the propagation path is vertical. In this case, however, this is a false assumption, and changes above a point do not impact the points vertically below, but points 24 below in a direction normal to the reflector which is the real direction of the propagation path.

FIG. 3 illustrates the proposed improvement on the current techniques. This present invention uses an approach similar to the classical 4D inversion (including warping) but instead of considering vertical traces, it creates new traces 30 along the energy path normal to the reflectors 32. Therefore, the previous assumptions become valid whatever the complexity of the geological model. Note that it is only the traces through the reservoir which matter here, what happens to the traces above the reservoir is not important (as indicated by the dotted arrow). If several reservoirs are parallel, tracing one ray will be sufficient for calculating the energy path of all reservoirs, whatever the overburden.

FIG. 4 is a flowchart illustrating the proposed approach. The first block 40 corresponds to classical processing applied to the base and monitor surveys for creating a seismic image. Depth migration is increasingly used instead of time migration because it is more accurate, especially in complex areas, although either is applicable to the present method.

The second block 42 is the key step of the proposed technique. It consists in creating/extracting new traces along which the energy has propagated rather than using the vertical traces, as indicated in FIG. 3. This amounts to transforming the data into a new 1D space.

The third block 44 corresponds to the current technique usually applied directly to time migrated traces, but here it is applied to the reconstructed traces extracted from the previous block. The output of this block is the 4D signal. If applied to post stack data, this can be, for example: change in P-wave velocity ΔVp (Warping), ΔVp and Δdensity if using the Cal4D approach, or change in impedance Δlp for classical 4D inversion. If applied on pre-stack data, the 4D signal can be, for example: ΔVp, change in S-wave velocity ΔVs, Δdensity (warping or Cal4D), or Δlp Δls (in classical 4D inversion) or even ΔPressure and ΔSaturation if a pressure and saturation inversion has been added to the process. In techniques that use cross-correlation to align the base and monitor surveys, applying the cross-correlation after the transformation improves the results compared to making the time shift alignment vertically.

It should be appreciated that the actual inversion may use any known or future developed inversion techniques, including all those mentioned in the introductory section above where propagation has, up to now, been assumed vertical.

The fourth block 46 is an inverse transform which transforms the results of the 4D inversion from the transform space back to the physical space.

To construct the propagation paths along which the energy has travelled, as described in block 42, rays can be traced perpendicular to the reservoir(s), in both upward and downward directions. This can be done using:
a shape of the reservoir, as determined by any of the many ways that would be readily apparent to the skilled person, e.g. by calculating the difference between the migrated base and migrated monitor and picking the main amplitude.
a pre-defined velocity model (e.g. that of the migration).

The seismic amplitudes are extracted along the rays (on the base and monitor surveys) with a dense sampling to create the traces required for the 4D inversion.

It must be appreciated that this is just one example of how the forward transform can be created. Other methods are equally applicable and are within the scope of the invention. These include: tracing rays in the time domain (an example of this can be found in the paper by Raynaud and Thore, 1993, Real time migration operators simulated by anisotropic ray tracing, presented at the 55th EAEG technical meeting, Stavanger (Abstracts C045), which is hereby incorporated herein by reference), using the paraxial wave equation, interpolation of sparse rays, plane wave propagation. The transform can be very precise (e.g. dense ray tracing or paraxial wave equation) or partial and approximate (e.g. as in the case of simple rotation illustrated on FIGS. 5a and 5b and described below). It can be conducted on time or depth migrated data. The transform can be made for each reservoir or for an “average reservoir”, i.e. globally for all superimposed reservoirs using an average dip.

FIGS. 5a and 5b illustrate the transform step using a simple rotation method. FIG. 5a is the difference between base and monitor seismic images of a dipping reservoir with layers that are clearly not horizontal. This shows clearly that the impact of the reservoir is not vertical but normal to the reservoir. FIG. 5b is the difference between the base and monitor images after their approximate transformation to 1D space, in this case using a simple rotation such that the layers are now approximately horizontal.

FIGS. 6a and 6b illustrate how ray tracing can be used to define the transformation. FIG. 6a shows Initial prestack depth migration (PSDM) of a base seismic survey (the same technique is performed on the monitor survey) with computed rays 60. The area bounded by the dotted line contains layers that can be seen to be substantially non-vertical. Within this area, the rays 60 are traced normal to reflectors, using the migration velocity model, and data are extracted along the rays 60, thereby following the energy path. The transformation further includes spatial interpolation between rays 60.

FIG. 6b shows the seismic data in time after transformation. As can be seen, the layers are predominately horizontal. As mentioned previously, it is on this transformation (or that shown in FIG. 5b) that the inversion is carried out. The results can then be transformed back into normal space.

The inverse transform is performed in an opposite way to the original transform into 1D space, for example by taking at each ray step the value of the estimated 4D signal. It may be an explicit inverse transform (e.g. for the case of a simple rotation, the inverse transform is just the rotation of transformed data with an opposite angle) or a mapping of the data from the transform space into the normal space using the forward transform.

FIG. 7a illustrates this mapping of the data using the forward transform T. Mapping comprises computing the forward transform again, but this time instead of putting a value from the normal space to the transform space, the value of the transform space is put back into the normal space (after the required interpolation, any simple interpolation sufficing). With the direct transform, a regular sampling of the normal space A is started with, from which points are computed on a regular grid in the transform space A′. Regular positions in the transform space do not correspond to regular position in the normal space. Therefore it is necessary to interpolate positions in the normal space. The illustration shows rays R′ in the transform space and rays R in the normal space.

FIG. 7b illustrates the mapping using the inverse transform T⁻¹. In the inverse transform T⁻¹ the aim is to be on the regular grid A in the real space. Regular positions in the real space do not correspond to regular position in the transform space A′. Therefore it is necessary to interpolate the positions in the transform space A′.

The methods described herein can be applied to all types of 4D inversions: pre stack-post stack, possibly including a transformation of 4D signals to pressure and saturation parameters. The pre-stack approach is merely a set of post stack approaches (one for each offset) for sections in the common offset domain.

By constructing traces along which the energy has travelled rather than using vertical traces, the reconstructed data verifies all the assumptions of 4D inversion: if an anomaly occurs at a depth z, corresponding to time t, such as a change of velocity due to oil production, this change will only impact the same trace below this perturbation. Even if the transform to 1D space is inexact, the inversion of the reconstructed data will still bring an improvement over the inversion performed with the assumption that all traces are vertical.

The processes described herein may be embodied in a computer program. The program is adapted to receive data for the base and monitor surveys, as well as data for the velocity fields; such data are in the format provided by state of the art computer packages. The program runs the various steps of the process of FIG. 4 or else as described herein.

It should be noted that the above examples are for illustration only and that other embodiments and examples can be envisaged without departing from the spirit and scope of the invention.

1. A process for characterising an evolution of a reservoir by analyzing changes of at least seismic amplitudes of seismic reflections, the process comprising:
providing a base survey of the reservoir with a first set of seismic traces at a first time;
providing a monitor survey of the reservoir, taken at a second time, with a second set of seismic traces associated to same positions as in the base survey;
characterising the evolution of the reservoir by inversion of the first set and the second set of seismic traces from the base survey and the monitor survey to obtain an estimate of changes having occurred in a time interval between the base survey and the monitor survey;
wherein, where said reservoir comprises layers that are substantially non-horizontal, said inversion is performed using seismic traces for which allowance is made for actual propagation paths through the non-horizontal layers.

2. The process as claimed in claim 1 comprising:
performing a transform on the base survey and the monitor survey in order to make said allowance for the actual propagation paths through the non-horizontal layers; and
performing said inversion on said transformed surveys.

3. The process as claimed in claim 2 wherein said transform is a transform to a one-dimensional space.

4. The process as claimed in claim 2 wherein said transform comprises at least one of creating and extracting new traces along expected propagation paths through the reservoir.

5. The process as claimed in claim 4 wherein said propagation paths are computed using rays normal to the reservoir layers.

6. The process as claimed in claim 4 wherein the transform further includes spatial interpolation between rays.

7. The process as claimed in claim 4 wherein said transform is determined by:
determining a shape of the reservoir; and
computing traces using a migration velocity model derived from the base survey and the monitor survey.

8. The process as claimed in claim 2 wherein said transform rotates the base survey and the monitor survey such that the layers are substantially horizontal.

9. The process as claimed in claim 2 comprising performing an inverse transform back to real space.

10. The process as claimed in claim 2 wherein a cross-correlation is used to align the base survey and the monitor survey in time prior to said characterising of the evolution of the reservoir by analysis of the changes in the seismic amplitudes of the seismic reflections, said cross-correlation being performed on at least one of the transformed base survey and the transformed monitor survey.

11. The process as claimed in claim 1 wherein the characterising of the evolution of the reservoir is performed by co-analyzing the changes in the propagation times with the seismic amplitudes of the seismic reflections.

12. The process as claimed in claim 1 wherein the base survey and the monitor survey have been previously depth or time migrated.

13. The process as claimed in claim 1 applied iteratively on more than one reservoir.

14. The process as claimed in claim 1 applied globally on more than one reservoir.

15. The process as claimed in claim 1 comprising the step of using resultant data to aid hydrocarbon recovery from the reservoir.

16. A computer program residing on a computer-readable medium, comprising computer program code adapted to run on a computer all the steps of the process of claim 1.

17. An apparatus specifically adapted to carry out the process of claim 1.
